(19) United States
(12) Patent Application Publication
(10) Pub. No.: US 2004/0030574 A1
(43) Pub. Date: Feb. 12, 2004

(54) System and method of warranting products monitored for proper use

(76) Inventors: Donald J. DiCostanzo, Irving, TX (US); Victor Keller, Corinth, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/621,770

(22) Filed: Jul. 17, 2003

Related U.S. Application Data
(60) Provisional application No. 60/401,016, filed on Aug. 1, 2002.

(51) Int. Cl. G06F 17/60

(52) U.S. Cl. 705/1

(57) ABSTRACT

Aspects of the present invention include a product warranty program that can be offered to cover damage to products that deteriorate through improper consumer use. The product warranty program comprises one or more product monitors and a product warranty agreement. The product monitors provide for convenient product monitoring to help ensure and facilitate that product's proper use, thereby protecting the user from product failure caused at least in part by excessive wear and/or the improper use. Moreover, the product warranty agreement warrants, among other things, that when the product monitors are properly used, the consumer is protected from, for example, repair and/or replacement costs of the product.

### REFERENCE TO RELATED APPLICATIONS

This application claims the benefit of U.S. Provisional Application No. 60/401,016, filed Aug. 1, 2002, and entitled “Product Warranty Program.” The present application incorporates the foregoing disclosure herein by reference.

### BACKGROUND OF THE INVENTION

1. Field of the Invention

The present disclosure relates in general to product warranty programs, and in particular to tire warranty programs.

2. Description of the Related Art

Product manufacturers often warrant their products against defects. However, such defect warranties rarely cover degradation of the product from the wear and tear caused by product use. Therefore, many, retailers offer additional or extended (“after-market”) warranties to provide repair or replacement protection. However, such after-market warranties often ignore the effects of improper use and the benefits proper use provides, such as, for example, protection from product failure and prevention of excessive wear. For example, most after-market warrantors, and in many cases even the consumers themselves, have difficulty monitoring products to determine whether any excessive wear or damage stems from improper use. Accordingly, conventional defect warranties and many after-market warranties focus on protection from replacement or repair costs and ignore the potential of product monitoring to avoid excessive wear.

Some products, like vehicle tires, are often improperly used in a manner that at best causes excessive and often uneven tire wear, and at worst, causes, contributes to, or increases the severity of vehicle accidents. For example, improper inflation of vehicle tires may result in otherwise avoidable accidents or injury and nearly always results in excessive, uneven, and sometimes dangerous wear. The excessive wear may necessitate early tire repair or even replacement. Accordingly, consumer tire costs can be correlated to some degree with the consumer's ability to frequently or continuously monitor the pressure in their vehicle tires.

However, it is often impractical to expect consumers or even experts to recognize an underinflated tire simply by simply looking at the tire shape. Therefore, many consumers purchase various portable tire pressure gauges only to find that portable tire pressure gauges include a number of drawbacks. For example, tire pressure gauges are easily lost and are inconvenient, often requiring vehicle operators to bend down, remove the tire stem cap, and in the process, cover their hands with brake dust or other common tire grime. Based on the foregoing, many vehicle operators, such as commuters, who spend large amounts of time in their cars wearing work clothing are not likely to use portable tire pressure gauges to ensure proper inflation of their tires.

To alleviate some of the hassle of portable tire pressure gauges, several manufactures offer tire stem pressure gauges. Tire stem pressure gauges attach to the tire stem and conveniently provide visual indications of whether the tire is properly inflated. However, to date, consumers have not been motivated to purchase such tire stem pressure gauges and therefore, tire stem pressure gauges have not been widely distributed.

Embodiments of the present disclosure seek to overcome some of all of these and other drawbacks.

### SUMMARY OF THE INVENTION

Accordingly, aspects of the present disclosure include a product warranty program comprising a product monitor and a product warranty agreement warranting that when the product monitor is properly used, the product monitor will prevent excessive wear or damage to the product. In an embodiment, notwithstanding improper use, if such damage or excessive wear occurs, the warrantor will reimburse the warranty holder repair and/or replacement costs associated with the excessive wear or damage.

In an embodiment of the disclosure, the product comprises one or more vehicle tires, the product monitor comprises one or more tire pressure monitors, and the product warranty agreement warrants, among other things, that when properly used, the one or more tire pressure monitors will identify underinflation of the one or more tires, particularly active vehicle tires. In an embodiment, the tire pressure monitors advantageously allow a vehicle operator to conveniently ensure proper tire pressure in each tire by simply and frequently visually inspecting the monitor. The monitor may include indicia, such as a number, indicating the tire pressure or tire pressure ranges. Also, the indicia may include commonly understood colors, such as, for example, red, yellow and/or green indicating respectively dangerous, cautious, and acceptable tire pressure conditions. In an embodiment, the tire pressure monitors comprise tire stem pressure gauges for each of the tires.

In an embodiment, the product warranty agreement can comprise tire repair or replacement, wheel or rim repair or replacement, can be transferable, can include varying coverage limits depending upon purchase price of the product warranty program, can cover some or all of the life of the tires, some or all of the life of the purchasing consumer's ownership of the tires, combinations of the same, or the like. Moreover, repair or replacement costs furnished by the warranty agreement can be based on geographical or industry standards, brands, size, vehicle characteristics, rim characteristics, types of vehicle uses, combinations of the same, or the like.

According to an embodiment, the product warranty program can be purchased at the time of sale of the product monitors or other related or warranted products. For example, the tire pressure monitors and tire warranty agreement can be offered at the time of an automobile purchase, such as, for example, a new car purchase. In this example, the purchase price of the product warranty program can be included as an addition to a monthly payment on a financed vehicle, paid as a cash up-front cost, or a combination of the same. Moreover, the tire pressure monitors can be attached before a consumer sale and brought to the consumer's attention during the financing or purchasing process.

In other embodiment, the purchase price of the product monitoring program can be included in or offered during a wide variety of purchases, such as, for example, the purchase of new or replacement tires, of automobile scheduled or other maintenance or repair, or the like.

For purposes of summarizing the invention, certain aspects, advantages, and novel features are described herein. Of course, it is to be understood that not necessarily all such aspects, advantages or features will be embodied in any particular embodiment of the invention.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 illustrates a block diagram of an embodiment of a product warranty program including a product monitor and a product warranty agreement.

FIG. 2 illustrates a flow chart of an embodiment of a registration process for the product warranty program of FIG. 1.

FIG. 3A illustrates a perspective view of an embodiment of the product monitor of FIG. 1, comprising a tire stem pressure gauge.

FIG. 3B illustrates a top plan view of the tire stem pressure gauge of FIG. 3A.

FIG. 4 illustrates an embodiment of the product warranty agreement of FIG. 1, comprising a simplified product warranty form.

### DETAILED DESCRIPTION OF THE PREFERRED EMBODIMENT

Aspects of the present invention include a product warranty program comprising a product monitor and a product warranty agreement. The product monitor provides for convenient consumer monitoring of a monitored product to help ensure and facilitate that product's proper use. The product monitor agreement warrants that when the product monitor is properly used, the product monitor will prevent excessive wear or damage to the monitored product. In an embodiment, when damage or excessive wear occurs to the monitored products, the warrantor will reimburse the warranty holder repair and/or replacement costs associated with the excessive wear or damage.

According to an embodiment, the product warranty program can be offered at the time of product purchase. For example, the product can be initially provided to the consumer with the product monitor assembled and, when appropriate, applied to the product. After explanation of function and use of the product monitor, the seller can explain that the product monitor is backed by a product warranty, and that the product warranty program is available for purchase. When the purchaser agrees to purchase the product warranty program, the purchaser completes warranty registration and the purchase price of the program can be included in, for example, the purchase price of the product monitors and/or the monitored product. When the purchaser declines to purchase the product warranty program, the product monitor can be removed.

Although disclosed with reference to offering the product warranty program at the time of sale, the disclosure is not limited thereto. Rather, an artisan will recognize from the disclosure herein that the product warranty program can be offered separately, at the time of purchase of a replacement product, at the time purchase of a used product, prorated for a wide variety of circumstances, combinations of the foregoing, scheduled or other service to the product monitor or the monitored products, or the like.

According to one embodiment, the product comprises vehicle tires, the product monitor comprises tire pressure monitors, and the warranty agreement warrants that when the tire pressure monitors are properly used on active vehicle tires, the purchaser of the product monitors is protected from repair or replacement caused by underinflated tires. The tire pressure monitor includes one or more devices that include easily identifiable indicia visually and conveniently informing the vehicle operator whether the tire is properly inflated. For example, the indicia may include a number indicating the tire pressure or tire pressure ranges. Also, the indicia may include commonly understood colors, such as, for example, red, yellow and/or green indicating respectively dangerous, cautious, and acceptable tire pressure conditions. In an embodiment, the tire pressure monitors comprise tire stem pressure gauges for each of the vehicle tires. According to one embodiment, the tire stem pressure gauges comprise those commercially available from Pep Boys®. Moreover, additional disclosure of tire stem pressure gauges similar to those of the present disclosure can be found in U.S. Pat. No. 6,374,666, issued Apr. 23, 2002 to Gary Lemberger et al., U.S. Pat. No. 5,886,254, issued Mar. 23, 1999 to Jiaa Chi, U.S. Design Pat. No. 2,225,675, issued Dec. 24, 1940 to W. S. West, and U.S. Pat. No. 1,807,752, issued Jun. 2, 1931 to M. J. Poster, the disclosures of which are incorporated herein by reference.

Alternatively, technologies that provide tire pressure data to a computing device can be used to monitor the pressure in the tires. In one embodiment, the computing device can include an on-board automobile computing system that is capable of presenting information, such as, for example, the foregoing inflation or pressure indicia to the operator of the vehicle.

As disclosed in the foregoing, the tire warranty agreement can warrant, among other things, that when the tire pressure monitors are properly used, the purchaser of the tire pressure monitors is protected from repair or replacement caused by underinflated tires. The warranty agreement may also cover rim repair or replacement, can be transferable, can include varying coverage limits depending upon purchase price, can include maximum and/or minimum coverage amounts, can include varying purchase prices based on varying coverage packages, can cover some or all of the life of the tires, some or all of the life of the purchasing consumer's ownership of the tires, combinations of the same, or the like. Moreover, repair or replacement costs covered by the warranty agreement can be based on geographical or industry standards, brands, size, vehicle characteristics, rim characteristics, types of vehicle uses, combinations of the same, or the like.

Although disclosed with reference to tires, an artisan will recognize from the disclosure herein that the product warranty program can be applied to many products capable of being monitored for proper use. Moreover, to facilitate a complete understanding of the disclosure, the remainder of the Detailed Description describes the invention with reference to the drawings, wherein like reference numbers are referenced with like numerals throughout.

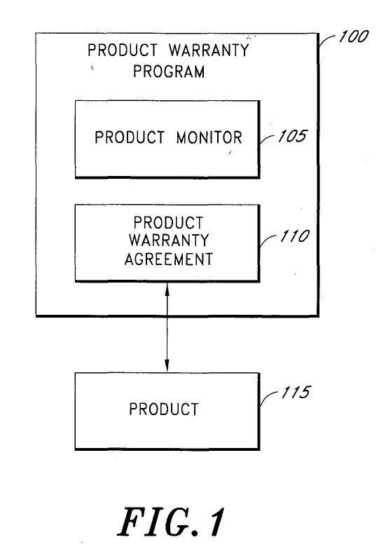

FIG. 1 illustrates a block diagram of an embodiment of a product warranty program 100 including a product monitor 105 and a product warranty agreement 110 that covers repair or replacement of a product 115. As disclosed in the foregoing, the product monitor 105 helps ensure and facilitate proper operation or use of the product 115. Moreover, when damage or excessive wear to the product 115 occurs during use of the purchased product monitor 105, the product warranty agreement 110 in an embodiment warrants, among other things, that the warrantor will repair the damage or the excessive wear, and/or replace the product 115.

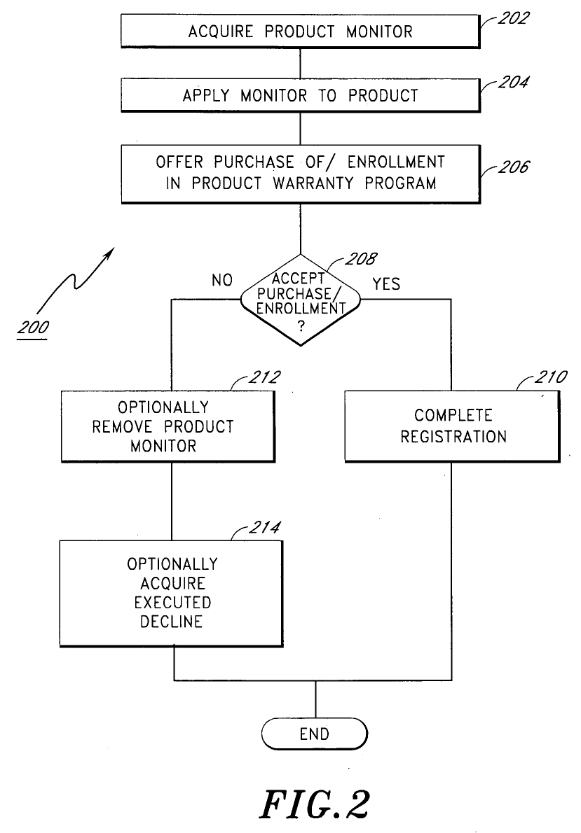

According to one embodiment, a purchaser enrolls in the product warranty program 100 at the time of product acquisition, product purchase and/or the acquisition or purchase of the product monitor 105. Moreover, the purchaser may enroll in the product warranty program 100 using, for example, the registration process of FIG. 2.

FIG. 2 illustrates a flow chart of an embodiment of a registration process 200 for the product warranty program 100 of FIG. 1. As shown in FIG. 2, the registration process 200 begins, for example, when at block 202, the enroller acquires the product monitor 105. In block 204, the product monitor 105 is applied to the product 115. As disclosed in the foregoing, the product monitor 105 may advantageously be applied or otherwise installed prior to a purchaser's/enroller's purchase of the product 115 such that block 202 through block 204 occurs before the purchaser/enroller acquires or purchases the product 115. However, an artisan will recognize from the disclosure herein that the product monitor 105 can be applied to the product 115 at any time, such as, for example, prior to initiation of coverage of the product warranty agreement 110, after purchase of the product monitor 105, or the like.

The registration process 200 continues with block 206 where the enroller is offered the product warranty program 100. When the enroller reviews the product warranty agreement 110 and determines that they desire to enroll, the enroller in block 210 completes a registration form, such as, for example, providing demographic information and/or execution of the product warranty agreement 110. When the enroller reviews the product warranty program 110 and determines not to enroll, the registration process 200 proceeds to block 212 where, when necessary, the product monitor 105 is removed from the product 115. The enroller may also in block 214 optionally be asked to verify their determination by executing a refusal notice, thereby opting not to purchase the product warranty program 100.

As disclosed in the foregoing, the product warranty program 100 advantageously provides for consumer protection against excessive wear and tear of the product 115 through improper use by combining the purchase of the product monitor 105 with the product warranty agreement 110. Moreover, through the enrollment process 200, the warrantor can ensure that the product monitor 105 is properly installed and whether the purchaser/enroller desires to enroll in the product warranty program 100 by, for example, executing the product warranty agreement 110.

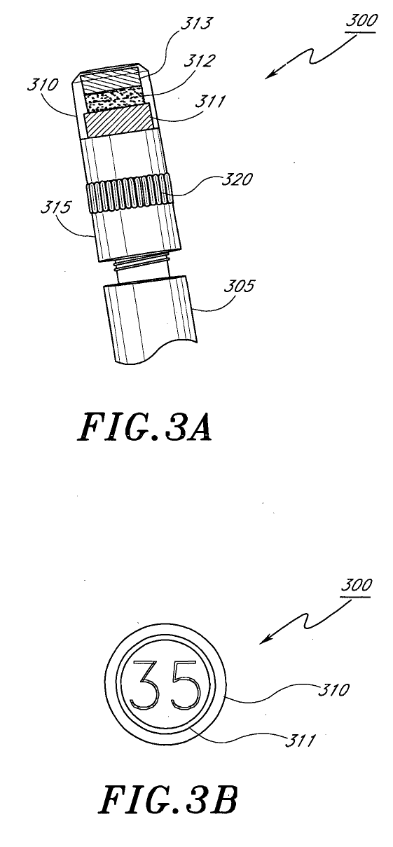

FIG. 3A illustrates a perspective view of an embodiment of the product monitor 105 of FIG. 1, comprising a tire stem pressure gauge 300 attached to a tire stem 305. According to one embodiment, the tire stem pressure gauge 300 is similar to the stem gauge disclosed in U.S. Pat. No. 5,886,254, issued Mar. 23, 1999 to Jiaa Chi, disclosed in the foregoing. For example, the tire stem pressure gauge 300 can comprise a transparent cover 310 attached to a hollow cylindrical metal housing 315 threadably attached to the tire stem 305.

In general, the air pressure in the tire stem 305 pushes against a floating seat (not shown) attached to a spring or tension-providing device (not shown). Since the spring or tension-providing device has elasticity, different air pressures in the tire stem 305, and thus the tire, cause the floating seat to move as the spring stretches or compresses. This motion can be mechanically or otherwise combined to cause different colored bolts to show through the transparent cover 310. In one embodiment, a green bolt 311 showing through the transparent cover 310 can be associated with the air pressure in the tire stem 305 being within an acceptable range. At proper inflation, the green bolt 311 rises to surround, and therefore, substantially cover, a second fixed bolt having a yellow upper portion 313 and a red lower portion 312. As the tire pressure falls, the green bolt 311 lowers, first showing the yellow upper portion 313 and then showing the red lower portion 312 through the transparent cover 310. Thus, through the motion of the green bolt 311, a viewer can readily visually ascertain whether the inflation in the tire is at an acceptable state, a cautionary underinflated state (yellow), or at a severely underinflated state needing immediate attention (yellow and red) by simply looking at the stem pressure gauge 300.

FIG. 3B illustrates a top plan view of the tire stem pressure gauge 300 of FIG. 3A, where the transparent cover 310 includes indicia indicating at what pressure or pressure range the gauge 300 will show an acceptable inflated state. For example, as shown in FIG. 3B, the transparent cap 310 includes the number “35,” indicating the pounds per square inch (PSI) that the gauge 300 will indicate proper tire pressure. According to one embodiment, the gauge 300 is available for PSI ratings from about 26 PSI to about 60 PSI in 2 and 3 pound increments, although an artisan will recognize from the disclosure herein that the gauge 300 could be manufactured for virtually any PSI rating or range.

The tire stem pressure gauge 300 may also include a plurality of gripping ridges 320 (FIG. 3A) to assist a person in threading the metal housing 315 around the threads of the tire stem 305.

Based on the foregoing, the product monitor 105 for a vehicle or other tire can comprise the tire stem pressure gauge 300, thereby conveniently and visually providing the vehicle operator the ability to determine whether the tires are underinflated. An artisan will also recognize from the disclosure herein that the product monitor 105 for a tire can comprise a wide variety of pressure sensing devices, including but not limited to tire stem gauges showing some or different indicia than that disclosed in the foregoing, such as a moving dial or pin against fixed numbers, multiple moving color-colored bolts, combinations of the same, or the like. Moreover, the artisan will recognize from the disclosure herein that the product monitor 105 for a tire can include sophisticated electronic monitors communicating with, for example, a car computing system designed to inform and/or alert the vehicle operator of the pressure or lack thereof in the active or other tires.

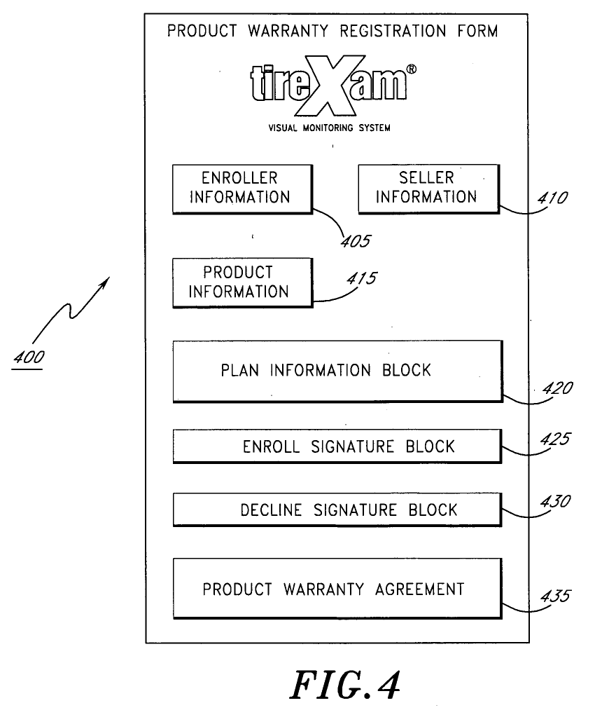

FIG. 4 illustrates a simplified embodiment of the product warranty agreement 110 of FIG. 1, comprising a simplified product warranty registration form 400. As shown in FIG. 4, the form 400 can include a purchaser/enroller information block 405, a seller information block 410, a product information block 415, a plan information block 420, a registering enroller signature block 425, a declining enroller signature block 430, and some or all of the actual warranty agreement 435. In general, the enroller information block 405 includes demographic or other information related to the enroller/purchaser. The seller information block 410 includes demographic and/or seller number information about the seller. For example, in an embodiment where the product 115 comprises tires, the seller may include a car salesman and/or dealership. In some embodiments, the warrantor may desire to encourage or incentivize the seller, such as dealerships, to further encourage car purchasers to enroll in the product warranty program 100. The incentives may include a portion of the purchase price, discounted or free product monitors like the foregoing tire stem pressure gauge 300, other compensation arrangements, combinations of the same, or the like. An artisan will recognize from the disclosure herein that many other type of sellers or retailers of product monitors can be incentivized through similar or other incentive programs to encourage purchasers of product monitors or products being monitored to enroll in the product warranty program 100.

The product warranty form 400 also includes the plan information block 420. The plan information block 420 may include the option to select from one or more warranty plans which, for example, may vary the maximum and/or minimum coverage limits, the purchase price charged, the geographic area or other conditions of use of the product 115, combinations of the same, or the like. The registering enroller signature block 425 and the declining enroller signature block 430 provide signature lines and dates for respectively enrolling and declining enrollment into the product warranty program 100.

The warranty agreement 435 may include a summary of and/or the entire provisions of the warranty agreement 110. An example of the warranty agreement 110 may comprise some or all of the following provisions, which should be understood as being provided for purposes of illustration and should not be understood as being provided for the purpose of limitation or for the purpose of changing the plain and ordinary meaning of any terms in the appended claims.

Exemplary Warranty

Other terms and conditions below are incorporated herein and binding upon the Warranty Holder. This Limited Product Warranty Agreement is between the Warranty Holder and The Warrantor and the Seller has no ongoing obligation to Warranty Holder with respect to this agreement. Warranty Holder acknowledges that this product is being made available as an optional product by the Seller, and the Seller makes no warranties (either expressed or implied) with respect to the product offered under this warranty program.

TO THE EXTENT PERMITTED BY LAW, ANY IMPLIED WARRANTIES OF MERCHANTABILITY AND/OR FITNESS FOR A PARTICULAR PURPOSE CREATED BY THIS LIMITED PRODUCT WARRANTY AGREEMENT ARE LIMITED IN DURATION TO THE SAME DURATION AS THIS EXPRESS WRITTEN WARRANTY. THE WARRANTOR SHALL NOT BE LIABLE FOR ANY INCIDENTAL OR CONSEQUENTIAL DAMAGES.

Some states do not allow limitations on the duration of an implied warranty, or the exclusion or limitation of incidental or consequential damages. If that is the case in your state, the above limitation or exclusions may not apply to you. Your specific legal rights may vary from state to state.

This agreement is a product warranty and is not insurance. It is not subject to state insurance laws but is subject to state laws concerning warranties.

The purpose of the Warrantor's tireXam® VISUAL MONITORING SYSTEM Product Warranty (this “Product Warranty”) is to give you, the Warranty Holder, the means to improve the life expectancy of the tires on this vehicle through the tireXam® Visual Monitoring System (the “tireXam® System”) at the time of purchase of the vehicle or the tires. The tireXam® System monitors are specifically designed and tested to assure constant and accurate tire monitoring for your vehicle. The special tireXam® System (including the monitors) backed by this Product Warranty (together, the “Product Warranty Program”) are only available through authorized Sellers. You must use the tireXam® System as instructed in order to receive the benefits of this Product Warranty.

Protection Offered by this Warranty

As the original purchaser of a tireXam® System, you are entitled to all the benefits and conditions contained in this agreement (as long as you comply with the maintenance recommendations and safety warnings and any other terms and conditions contained in this agreement). To ensure your understanding of and compliance with the terms and conditions of this Product Warranty, please read it carefully. It is also essential that you read and understand the safety and maintenance recommendations for your tires. Consult your tire owner's guide for specific information.

The tireXam® System includes a monitor on the tire valve or stem of at least each active tire on the vehicle identified above. The Warrantor warrants that this tireXam® System will identify when your tires are underinflated so that you can ensure proper inflation. If the tireXam® System is used as directed but fails to appropriately identify underinflation in your tires and you experience tire failure due to a Road Hazard, the Warrantor will reimburse you up to the Limits of Liability (as defined below) the reasonable cost needed to repair or replace the tire(s) (subject to the terms, conditions and exclusions set forth herein). A Road Hazard is a condition on a public roadway which should not exist there, such as potholes, cracks, breaks, nails and glass. The tires and wheels that are covered are only those that were on the vehicle on the date that the Product Warranty Program was purchased. To determine the reasonable cost of a repair or replacement, the Warrantor will refer to the national average cost for similar repairs or replacements.

If a tire covered by this Agreement becomes unserviceable due to a Road Hazard and can be safely repaired, the Warrantor will cover the cost of the tire repair up to the Tire Repair Amount per occurrence. Any repair, installation, mounting, balancing and taxes will be reimbursed to the Warranty Holder or paid directly to the servicing Seller. If a tire covered by this Agreement becomes unserviceable due to a Road Hazard and cannot be safely repaired, it will be replaced with a tire of like kind and quality as the original tire including installation, mounting, balancing and taxes. In addition, if a wheel covered under this Agreement is damaged in conjunction with a covered tire due to a Road Hazard and cannot hold proper tire pressure, it will be replaced with a wheel of like kind and quality as the original wheel. Damage resulting in scrapes, scratches, chips or other cosmetic damage where the tire can hold proper tire pressure is not covered under this agreement.

Limits of Liability

The Warrantor's total liability during the entire Warranty Term (as defined below) shall not exceed the Max Liability for the Protection Program.

Validation and Effective Term of Warranty

This Product Warranty will become effective on the date of purchase of the tireXam® System and shall continue for the Term, unless the life of the Usable Tread (as defined in this paragraph) of the tire is shorter (the “Warranty Term”). The Usable Tread is defined as more than 3/32 of an inch of tread remaining on the tire. When the tire is worn down to 3/32 of an inch (or down to the tread wear indicators), the tire is worn out and the Warranty Term for that particular tire expires. The date of purchase is documented by a vehicle registration or sales invoice. In order for this Product Warranty to remain in effect, the tireXam® System monitors provided are to be kept on at least the active vehicle tires for the duration of the Warranty Term.

Coverage by Another Warranty

If a failure of a tire is covered by both a tire or vehicle manufacturer's warranty or a warranty or service contract issued by another company and this Product Warranty, then the Warranty Holder must first have the other warranty or service contract issuer pay for the repairs or replacement before making a claim under this Product Warranty.

Conditions and Exclusions

This limited Product Warranty does not cover economic loss, including loss of profit or income, loss of time, inconvenience, lodging, food or other incidental or consequential loss or damage not specifically listed as covered. Some states do not allow the exclusion or limitation of incidental or consequential damages, so the above limitation or exclusion may not apply to you. The monitors are to be on at least the active tires on the vehicle at the time of any claim under this Product Warranty. Tires presented for claim remain the property of the consumer and the Warrantor accepts no responsibility for loss of, or damage to, tires that are in the custody or control of a tire retailer or repair facility for the purpose of inspection for warranty adjustment. Further, this Limited Product Warranty does not cover Z-rated tires (unless Z-rated tire option is checked by the Seller on the front side of this agreement and proper cost is paid), wheels and tires over 20″ in diameter or any of the tires on a vehicle equipped with dual rear wheels. NO WARRANTOR REPRESENTATIVE, EMPLOYEE, RETAILER, OR THE SELLER HAS THE AUTHORITY TO MAKE OR IMPLY ANY REPRESENTATION, PROMISE OR AGREEMENT, WHICH IN ANY WAY ADDS TO OR IN ANY WAY VARIES THE TERMS AND CONDITIONS OF THIS PRODUCT WARRANTY.

Tires used on the following vehicles are not eligible and no coverage will be provided: Any emergency service vehicle, any vehicle used for hire, towing, construction, postal service or any other use deemed commercial. Any vehicle used for farms, ranch, agricultural, or off-road service. Any vehicle operated outside of the United States of America or Canada. Coverage excludes: Damage that existed prior to the sale of this agreement. Coverage excludes damage from off-road use (off-road use is defined as driving on anything other than a paved or gravel road maintained by state of local authority). Coverage excludes: Damage due to collision, impact with any object that is not defined as a Road Hazard, damage to tire sidewall, fire or other externally generated heat, vandalism, theft, snow chains, manufacturer's defects, normal wear, chemical contamination, neglect, under inflation (unless indicated by the tireXam® System and repaired/replaced as allowed under this Product Warranty) or over inflation, brake lock up, wheel spinning, torque snags or other abuse. Damage resulting from mechanical failure including but not limited to failed shocks or struts. Damage due to uneven or rapid tire wear (indicated by measured tread depth differences of 3/32nd of an inch or more across the tread on the same tire) which results from a mechanical irregularity in the vehicle such as misalignment. Damage resulting from interference with vehicle components including but not limited to fenders, exhaust, or springs. Tires that have been retreaded, recapped, regrooved, remolded, tubed or repaired in a manner other than per manufacturer's guidelines. Damage resulting from tires that are incorrectly mounted, any tire/wheel imbalance or any improper repairs of the tires. No coverage is provided for roadside assistance, towing costs or flat tire assistance. This plan will not pay for costs to repair or replace the tire covered under any tire manufacturer's limited warranty or recall or under any insurance plan.

Safety/Maintenance Information

Read and follow your tire owner's manual, the information on the sidewall of your tires, your vehicle owner's manual, and the vehicle tire information placard for safety and maintenance information. WARNING—Disregarding any of the safety precautions and/or instructions contained in these materials may result in tire failure or explosion causing serious personal injury or death.

How to Make a Claim

Call the tireXam® Administrative Claims Center prior to repairing or replacing the tire(s) or wheels(s) to obtain the Warrantor's authorization for the claim under this Product Warranty. The tireXam® administrator has the right to inspect any tire or wheel prior to authorizing a claim. For reimbursement of an authorized claim, submit a copy of this tireXam® VISUAL MONITORING SYSTEM PRODUCT WARRANTY PROGRAM registration form and your authorization number along with receipts for the repair or replacement The monitors must be on all the tires on the vehicle at the time of the claim. CLAIMS MUST BE SUBMITTED WITHIN THE A PREDEFINED NUMBER OF DAYS FROM THE WARRANTOR'S AUTHORIZATION DATE TO QUALIFY FOR REIMBURSEMENT.

Cancellation of Purchase

Cancellation by Warranty Holder: The Warranty Holder may cancel his or her purchase of the tireXam® Product Warranty Program within thirty (30) days of purchase. To cancel, the Warranty Holder should submit in writing to the Seller identified in the registration form both the date and mileage at the time of request for cancellation. All tireXam® monitors must also be returned to the Seller. The Warranty Holder may not cancel the purchase of the Product Warranty Program more than thirty (30) days after purchase. Your specific legal rights may vary from state to state.

Cancellation by the Warrantor: If the Seller or a lending institution finances the purchase price of the Product Warranty Program, and the vehicle is repossessed or destroyed, or the Warranty Holder is otherwise in default on his or her obligations to repay the amount financed, the Warrantor shall be entitled to cancel the purchase of the Product Warranty Program. In addition, the Warrantor reserves the right to cancel the purchase of the Product Warranty Program if it determines that the tires, wheels or vehicle was not eligible for coverage as specified under the Conditions and Exclusions described above.

Refunds: If the Product Warranty Program purchase is canceled within thirty (30) days of the purchase date and the Warranty Holder paid cash for the Product Warranty Program, the Seller will be responsible for issuing a full refund of the purchase price to the Warranty Holder. If the Product Warranty Program is canceled within thirty (30) days and the purchase price for the Product Warranty Program was financed, the Warrantor will refund either to the Seller or to the lending institution the full amount that the Warrantor received for the Product Warranty Program, and the lending institution will be responsible for crediting the Warranty Holder's loan balance with the full amount of the Product Warranty Program purchase price financed by the lending institution. The Warrantor will not make any full or partial refunds if the Warrantor has paid or authorized a claim associated with this Product Warranty.

Transfer Procedures

You may transfer the Product Warranty Program if you sell the vehicle during the Warranty Term. The new owner must pay a transfer fee to the Warrantor and provide his or her name, address, telephone number and a copy of the bill of sale to validate the transfer, together with the same information for the prior owner. The Warrantor must be notified within thirty (30) days after the date of sale of the vehicle for the transfer of the tireXam® System to the new owner to be effective. If you purchased the Standard Protection Program, you may not transfer the Product Warranty Program. The tireXam® System is not transferable from vehicle to vehicle nor can it be transferred to replacement tires.

Loss or Damaged Monitors

In the event any of the tireXam® System monitors are lost, stolen or damaged, it is your responsibility to replace them within 7 days. Damaged or inoperable monitors will be replaced at no charge provided they are returned postage prepaid to the Warrantor at the address below. Lost or stolen monitors will be replaced for a postage and handling fee paid in advance. Please send check or money order to the address below.

Disputes

In the event of a dispute between the Warranty and the Warranty Holder relating to the Product Warranty Program, such dispute shall be settled by final and binding arbitration by the American Arbitration Association in accordance with the Commercial Arbitration Rules of the American Arbitration Association, unless the Warrantor and the Warranty Holder agree to do otherwise. There shall be one (1) arbitrator and judgment on the award rendered by the arbitrator may be entered exclusively in any court having competent jurisdiction. The arbitration shall be held in the county and state where the Product Warranty Program was purchased, unless the Warrantor and the Warranty Holder agree to do otherwise. Each party shall pay its own fees in presenting its case (such as attorneys' fees, witness expenses, and travel expenses). Any fees paid to the American Arbitration Association and the arbitrator shall be shared equally by the Warrantor and the Warranty Holder. The arbitrator shall not award punitive damages or interest (including pre-award interest).

Entire Agreement, No Other Representations

This Product Warranty contains the terms and conditions of the Product Warranty that backs the tireXam® System. It supersedes all other statements, understandings or agreements between the Warranty and the Warranty Holder made before or at the same time the Product Warranty Program was purchased. The Warranty Holder acknowledges that he or she has not been induced to enter into this transaction by, nor is he or she relying on, any representation or warranty outside those expressly set forth in this Product Warranty, including any representation made by the Seller or any other individual selling the Product Warranty Program.

Although the foregoing invention has been described in terms of certain preferred embodiments, other embodiments will be apparent to those of ordinary skill in the art from the disclosure herein.

Additionally, other combinations, omissions, substitutions and modifications will be apparent to the skilled artisan in view of the disclosure herein. Accordingly, the present invention is not intended to be limited by the reaction of the preferred embodiments, but is to be defined by reference to the appended claims.

What is claimed is:

1. A method of warranting a product, the method comprising:
providing one or more product monitors capable of monitoring use of a product; and
providing a product warranty agreement warranting that when the one or more product monitors are properly used, the one or more product monitors will prevent excessive wear to the product and when excessive wear occurs, a warrantor will reimburse repair and/or replacement costs of the product.

2. The method of claim 1, wherein the product comprises vehicle tires.

3. The method of claim 2, wherein the one or more product monitors comprises one or more tire pressure monitors.

4. The method of claim 3, wherein each active tire on a vehicle includes one of the one or more tire pressure monitors.

5. The method of claim 3, wherein the one or more tire pressure monitors comprise one or more tire stem pressure monitors.

6. The method of claim 5, wherein each of the one or more tire stem pressure monitors comprises color-coded indicators that visually inform a vehicle operator whether a corresponding vehicle tire is underinflated.

7. The method of claim 1, wherein the purchaser is a purchaser of the product.

8. The method of claim 1, wherein the purchaser is a purchaser of the one or more product monitors backed by a product warranty agreement.

9. The method of claim 1, further comprising:
installing the one or more product monitors on products to be sold; and
offering the one or more product monitors backed by product warranty agreement during the sale of the product.

10. The method of claim 9, distributing the one or more product monitors to one or more sellers of the product.

11. The method of claim 10, further comprising sharing the revenue from the sale of the one or more product monitors backed by the product warranty agreement.

12. A product warranty program for preventing excessive tire wear due to improper inflation of active tires, the product warranty program comprising one or more tire pressure monitors backed by a warranty agreement protecting a purchaser of the one or more tire pressure monitors from tire repair and/or replacement costs related to improper performance of one or more tire pressure monitors.

13. The product warranty program of claim 12, wherein the one or more tire pressure monitors comprise one or more tire stem pressure monitors.

14. The product warranty program of claim 13, wherein each of the one or more tire stem pressure monitors comprises color-coded indicators that visually inform a vehicle operator whether a corresponding vehicle tire is underinflated.

15. The product warranty program of claim 12, wherein the tire warranty agreement includes different purchase prices relating to different coverage plans.

16. The product warranty program of claim 12, wherein the tire warranty agreement is offered at the time of the vehicle acquisition and/or purchase.

17. The product warranty program of claim 16, wherein one or more tire pressure monitors are installed on the vehicle prior to the acquisition and/or purchase.

18. The product warranty program of claim 16, wherein the vehicle is a new vehicle.

19. The product warranty program of claim 16, wherein the vehicle comprises are of a bicycle, motorcycle, automobile, a motor-powered machine, and a human-powered machine.

20. A product warranty program comprising:
means for monitoring the pressure in a vehicle tire; and
means for warranting that when the means for monitoring is used properly, a purchaser of the means for monitoring is protected from at least a portion of repair and/or replacement costs associated with excessive wear or damage to the vehicle tire due to improper inflation.

21. The product warranty program of claim 20, wherein improper inflation comprises underinflation.
